(19) United States
(12) Patent Application Publication
(10) Pub. No.: US 2006/0146957 A1
(43) Pub. Date: Jul. 6, 2006

(54) FSK signal generator

(76) Inventor: Kazuo Kawai, Tokyo (JP)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/182,436

(22) Filed: Jul. 15, 2005

(30) Foreign Application Priority Data
Jan. 1, 2005 (JP) 2005-022587

(51) Int. Cl. H04L 27/12

(52) U.S. Cl. 375/303; 332/100

(57) ABSTRACT

An FSK signal generator comprises a pulse generator which generates a first clock pulse of a frequency n, a second clock pulse of a frequency n/2, and a square wave pulse of a frequency n/2, a first bandpass filter which outputs a first carrier signal of a frequency n by driving of the second clock pulse, a second bandpass filter which outputs a second carrier signal of a frequency 1.5n by driving of the second clock pulse, a carrier signal selection circuit constituted of first through fourth controllable switches supplied with the first and second carrier signals and their phase-inverted signals, and a controller which generates select signals formed according to respective polarities of a data signal, an output FSK signal and a square wave pulse upon the supply of the first clock pulse. The select signals are supplied to the first through fourth controllable switches to close-operate one of them, whereby an FSK signal having contiguous phases is generated upon frequency shifting between the first and second carrier signals.

### RELATED/PRIORITY APPLICATION

This application claims priority with respect to Japanese Application No. 2005-022587, filed Jan. 1, 2005.

### BACKGROUND OF THE INVENTION

1. Field of the Invention

The present invention relates to an FSK signal generator, and particularly to an FSK signal generator which generates an FSK signal lying in a low frequency band at which the phase of an output signal is brought to a continuous state when the FSK signal is frequency-shifted, and which is suitable for use in the generation of an MSK signal.

2. Description of the Related Art

In general, an FSK signal is of a frequency-modulated signal set so as to become different first and second frequencies F1 and F2 in response to codes 0 and 1 of an input binary data signal and set so as to be frequency-shifted between the first and second frequencies F1 and F2 in response to changes in the codes of the binary data signal. When the FSK signal is frequency-shifted from the first frequency F to the second frequency F2 or frequency-shifted from the second frequency F2 to the first frequency F1, the waveform of the FSK signal is temporarily brought into an improper or disordered state upon its frequency shifting unless the phase of the resultant FSK signal is placed in a continuous state, so that an occupied bandwidth of the FSK signal is made wider than the original occupied bandwidth. Therefore, a voltage controlled oscillator (OSC) is normally used upon generation of the FSK signal, and an oscillation signal of the voltage controlled oscillator is frequency-modulated by a binary data signal to obtain the FSK signal.

The FSK signal can be made narrow in occupied bandwidth as a modulation index expressed in the ratio between its shift width and data rate becomes small. When the modulation index is 0.5, the occupied bandwidth of the FSK signal becomes the smallest. Such an FSK system that the corresponding signal is selected and frequency-modulated such that such a modulation index is reached, is particularly called “MSK (Minimum Shift Keying) system”.

As such a typical example that an FSK signal lying in a low frequency band is transmitted, there is known a system in which a data signal whose data rate is 1200 bits/s (bps) is frequency-shifted to 1200 Hz as a first frequency F1 and frequency-shifted to 1800 Hz as a second frequency F2. Such a system that such frequency shifting is set corresponds to the MSK system. Since the data rate is 1200 bits/s in the typical example in this case, a carrier signal corresponding to just one cycle is inputted during one bit if the FSK signal is frequency-shifted to the first frequency F1, whereas if the FSK signal is frequency-shifted to the second frequency F2, a carrier signal corresponding to just 1.5 cycle is inputted during one bit. Therefore, if the phases of the carrier signals of the first and second frequencies F1 and F2 are adjusted, then the phases of the first and second carrier signals can respectively be set so as to reach just a continuous state when the output FSK signal is frequency-shifted from the first frequency F1 to the second frequency F2 or frequency-shifted from the second frequency F2 to the first frequency F1. Upon execution of such a setting, the occupied bandwidth of the FSK signal becomes the narrowest.

Meanwhile, when an FSK signal lying in a low frequency band is generated using a voltage controlled oscillator, its oscillation frequency becomes low. Therefore, an inductance element L and a capacitance element C of a resonant circuit used in the voltage controlled oscillator result in ones having high reactance values respectively. When the inductance element L and the capacitance element C each having such a high capacitance value are used, the voltage controlled oscillator becomes disadvantageous upon its mounting because their occupied capacities are considerably increased. In order to avoid such a mounting disadvantage of the voltage controlled oscillator, the following two means have heretofore been used. The first means corresponds to a means wherein such a voltage controlled oscillator as to generate an FSK signal lying in a frequency band considerably higher than an FSK signal lying in a low frequency band intended to obtain or to try for is used as the voltage controlled oscillator, the FSK signal lying in the resultant high frequency band is reduced to the low frequency band to try for by frequency conversion, whereby a required FSK signal is obtained. The second means is of a means wherein an equation-based digital computing process is performed using a digital signal processor (DSP) to form a digital signal and the resultant digital signal is digital-analog converted to obtain a required FSK signal.

Incidentally, the first means is accompanied by the problem that since it aims to generate the FSK signal lying in the high frequency band by using the voltage controlled oscillator, there is no need to configure the resonant circuit by using the large-sized inductance element L and capacitance element C each having the high reactance value, whereas when the high frequency band is frequency-converted to the low frequency band, there is a need to provide various additional or attached circuits such as a local carrier generator, a bandpass filter, etc. as well as a frequency converter, and besides fluctuating components proportional to the center frequency and the frequency of a shift width or the like are frequency-shifted to within the low frequency band as they are, and appear in the required FSK signal.

On the other hand, the second means is capable of temporarily avoiding the problem that exists in the first means by using the digital signal processor. However, the second means is accompanied by another problem that if the digital signal processor is used in advance for the purpose of performing other digital signal processing, then the process of forming the FSK signal can be allowed to intervene while the digital signal processor is performing the present digital signal processing, whereas since there is no need to carry out other digital signal processing, it is necessary to additionally provide a digital signal processor for the purpose of the process of forming the FSK signal where the digital signal processor is not used, thus causing a rise in the manufacturing cost of an FSK signal generator correspondingly.

### SUMMARY OF THE INVENTION

The present invention has been made in view of such a background art. It is therefore an object of the present invention to provide an FSK signal generator capable of generating an FSK signal lying in a low frequency band continuous in phase by means of a simple circuit configuration based on normal components without using large-sized inductance and capacitance elements each having a high reactance value and using a digital signal processor.

In order to attain the above object, there is provided an FSK signal generator according to the present invention, which carries out FSK corresponding to codes of an input data signal to generate an FSK signal lying in a low frequency band, including first means comprising a pulse generator that generates a first clock pulse of a frequency n equal to a baud rate of the data signal, a second clock pulse of a frequency n/2 equal to ½ of the frequency n, and a square wave pulse of a frequency n/2 respectively; a first bandpass filter that has a pass band with the frequency n as the center and outputs a first carrier signal of a frequency n by driving of the second clock pulse; a second bandpass filter that has a pass band with a frequency 1.5n as the center and outputs a second carrier signal of a frequency 1.5n by driving of the second clock pulse; a carrier signal selection circuit comprising a first controllable switch supplied with the first carrier signal, a second controllable switch supplied with a phase-inverted first carrier signal, a third controllable switch supplied with the second carrier signal, and a fourth controllable switch supplied with a phase-inverted second carrier signal; and a controller that generates select signals selected and formed according to respective polarities of the data signal and output FSK signal and the square wave pulse upon the supply of the first clock pulse, wherein the select signals are supplied to the first through fourth controllable switches respectively and any selected one of the first through fourth controllable switches is close-operated to thereby generate an output FSK signal having contiguous phases upon frequency shifting between the first carrier signal and the second carrier signal.

The controller employed in the first means can be configured so as to include a comparator that generates a compared output obtained by comparing the output FSK signal with a reference potential, a ROM in which the data signal, the square wave pulse, the second clock pulse and the compared output are respectively address-inputted, and a decoder that decodes the output of the ROM to form each select signal.

In this case, the controller employed in the first means can be configured so as to include a comparator that generates a compared output obtained by comparing an output FSK signal with a reference potential, a first latch circuit supplied with the data signal and the second clock pulse, a second latch circuit supplied with the compared output and the second clock pulse, and a logic circuit section including a plurality of logic gates that digitally process the outputs of the first and second latch circuits, and to output and form the select signals from the logic circuit section.

In order to attain the above object, there is provided an FSK signal generator according to the present invention, which performs FSK corresponding to codes of an input data signal to generate an FSK signal lying in a low frequency band, including second means comprising a pulse generator that generates a clock pulse of a frequency n equal to a baud rate of the data signal and a square wave pulse of a frequency n/2 respectively; a first bandpass filter that has a pass band with the frequency n as the center and outputs a first carrier signal of a frequency n by driving of the clock pulse; a second bandpass filter that has a pass band with a frequency 2n as the center and outputs a second carrier signal of a frequency 2n by driving of the clock pulse; a carrier signal selection circuit comprising a first controllable switch supplied with the first carrier signal and a second controllable switch supplied with the second carrier signal; and a controller that generates select signals selected and formed according to respective polarities of the data signal and output FSK signal and the square wave pulse upon the supply of the clock pulse, wherein the select signals are supplied to the first and second controllable switches respectively and either selected one of the first and second controllable switches is close-operated to thereby generate an output FSK signal having contiguous phases upon frequency shifting between the first carrier signal and the second carrier signal.

According to each of the first means and the second means as described above, when the frequency shift corresponding to the codes of the input data signal is performed to generate the FSK signal lying in the low frequency band, the first carrier signal of the frequency n equal to the baud rate of the data signal and the second carrier signal of the frequency 1.5n or 2n are formed using the corresponding bandpass filter. The formed first carrier signal and the second carrier signal are supplied to the carrier signal selection circuit comprising the plurality of controllable switches, and one selected from the plurality of controllable switches is close-operated with predetermined timing, thereby making it possible to generate the output FSK signal having the contiguous phases upon frequency shifting between the first carrier signal and the second carrier signal. Thus, advantageous effects are brought about in that simply using a simple circuit configuration comprised of normal components on the whole enables generation of a stable FSK signal, and since overall frequency conversion is not performed and digital processing using a digital signal processor is not carried out, an inexpensive and small-sized FSK signal generator can be obtained without using various additional or attached circuits such as a local carrier signal generator, a bandpass filter, etc. and expensive devices such as the digital signal processor, etc.

Other features and advantages of the present invention will become apparent upon a reading of the attached specification.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 relates to a first embodiment according to the present invention and is a block diagram showing its fragmentary configuration;

FIG. 2 is a signal waveform diagram illustrating states of signals formed at respective parts of an FSK signal generator shown in FIG. 1;

FIG. 3 is a block diagram showing a first specific configuration example of a controller shown in FIG. 1; and

FIG. 4 is a block diagram illustrating a second specific configuration example of the controller shown in FIG. 1.

### DETAILED DESCRIPTION OF THE PREFERRED EMBODIMENTS

Preferred embodiments of the present invention will be explained hereinafter with reference to the accompanying drawings.

### First Preferred Embodiment

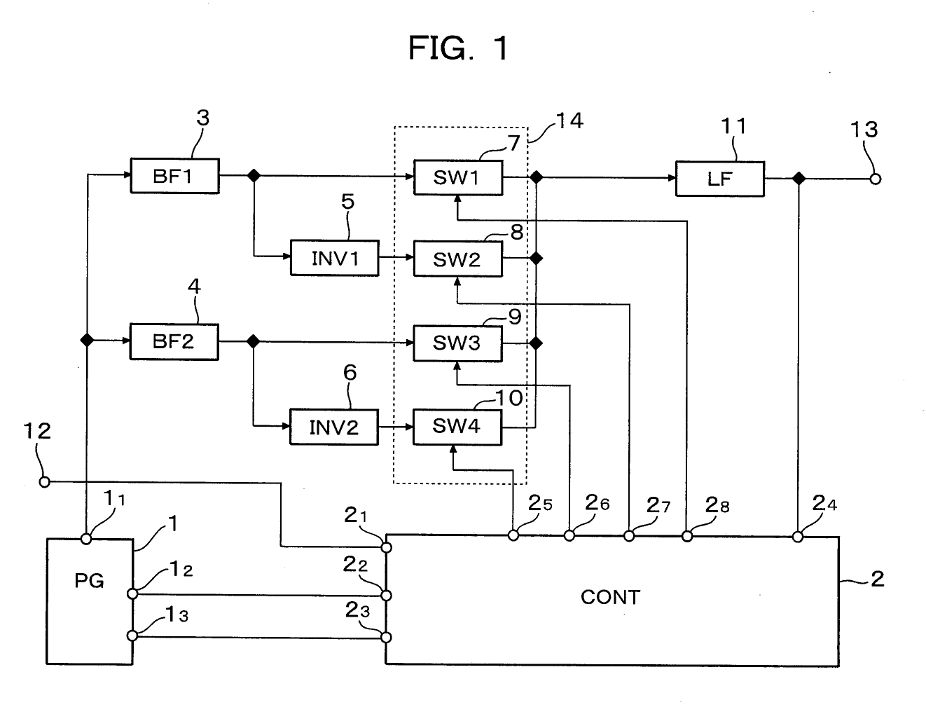

FIG. 1 relates to a first embodiment according to the present invention and is a block diagram showing a fragmentary configuration thereof. An FSK signal generator according to the first embodiment is illustrated as an example wherein when an FSK signal consisting of a first carrier signal and a second carrier signal, frequency-shifted corresponding to codes 0 and 1 of an input binary data signal is generated, it is frequency-shifted to a frequency 1200 Hz as the first carrier signal when the data signal is of the code 0, and it is frequency-shifted to a frequency 1800 Hz as the second carrier signal when the data signal is of the code 1, whereby MKS is executed.

As shown in FIG. 1, the FSK signal generator comprises a pulse generator (PG) 1, a controller (CONT) 2, a first bandpass filter (BF1) 3, a second bandpass filter (BF2) 4, a first phase inverter (INV1) 5, a second phase inverter (INV2) 6, a first controllable switch (SW1) 7, a second controllable switch (SW2) 8, a third controllable switch (SW3) 9, a fourth controllable switch (SW4) 10, a lowpass filter (LF) 11, a data signal input terminal 12, and an FSK signal output terminal 13. Here, a circuit section comprising the first controllable switch 7, the second controllable switch 8, the third controllable switch 9 and the fourth controllable switch 10 constitutes a carrier signal selection circuit 14. The pulse generator 1 has three terminals 1₁, 1₂, and 1₃, and the controller 2 has eight terminals 2₁, 2₂, 2₃, 2₄, 2₅, 2₆, 2₇ and 2₈.

In the pulse generator 1, the terminal 1₁ is electrically connected to an input terminal of the first bandpass filter 3, the terminal 1₂ is electrically connected to the terminal 2₂ of the controller 2, and the terminal 1₃ is electrically connected to the terminal 2₃ of the controller 2, respectively. In the controller 2, the terminal 2₁ is electrically connected to the data signal input terminal 12, the terminal 2₄ is electrically connected to an output terminal of the lowpass filter 11 and the FSK signal output terminal 13 respectively, the terminal 2₅ is electrically connected to a control terminal of the first controllable switch 7, the terminal 2₆ is electrically connected to a control terminal of the second controllable switch 7, the terminal 2₇ is electrically connected to a control terminal of the third controllable switch 9, and the terminal 2₈ is electrically connected to a control terminal of the fourth controllable switch 10. The first bandpass filter 3 has an output terminal electrically connected to an input terminal of the first controllable switch 7 and connected to an input terminal of the second controllable switch 8 through the first phase inverter 5, respectively. The second bandpass filter 4 has an output terminal electrically connected to an input terminal of the third controllable switch 9 and connected to an input terminal of the fourth controllable switch 10 through the second phase inverter 6, respectively. The first, second, third and fourth controllable switches 7 through 10 have output terminals all electrically connected to an input terminal of the lowpass filter 11.

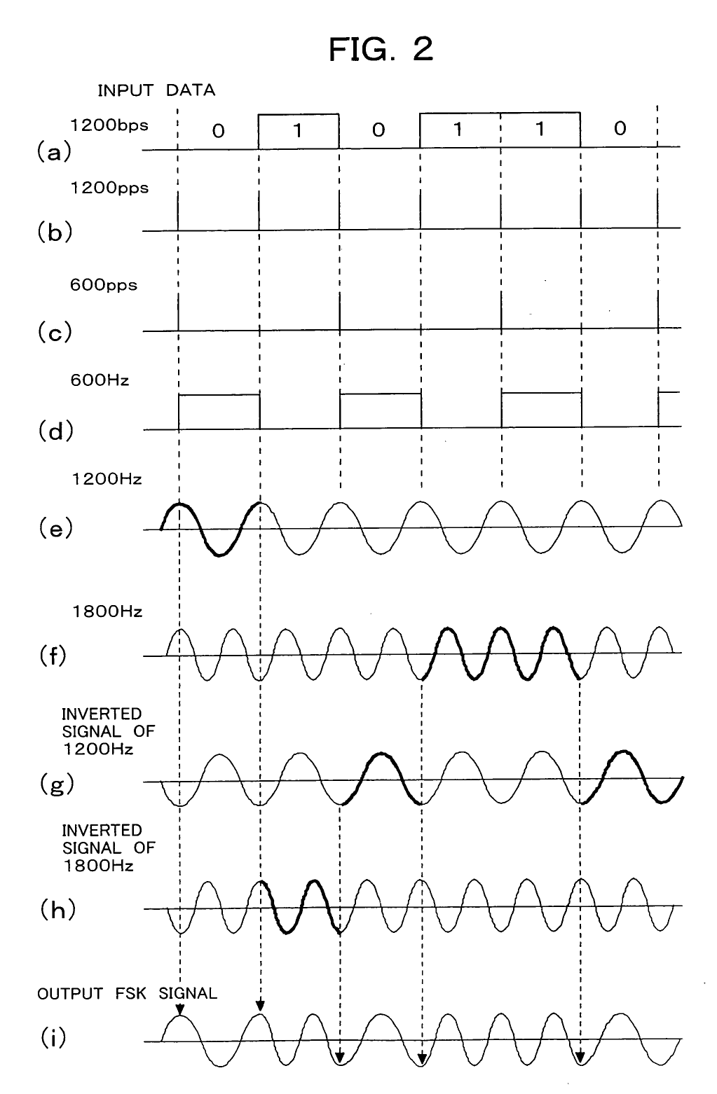

Now, FIG. 2 is a signal waveform diagram showing states of signals formed at the respective parts of the FSK signal generator illustrated in FIG. 1.

In FIG. 2, (a) indicates an input data signal of 1200 bps supplied from the data signal input terminal 12 to the terminal 2₁ of the controller 2, (b) indicates a first clock pulse of 1200 pps having a sharp waveform, which is outputted from the terminal 1₃ of the pulse generator 1 and supplied to the terminal 2₃ of the controller 2, (c) indicates a second clock pulse of 600 pps having a sharp waveform, which is outputted from the terminal 1₁ of the pulse generator 1 and supplied to the first bandpass filter 3 and the second bandpass filter 4, (d) indicates a non-return-to-zero (NRZ) square wave signal of 600 Hz which is outputted from the terminal 1₂ of the pulse generator 1 and supplied to the terminal 2₂ of the controller 2, (e) indicates a first carrier signal outputted from the first bandpass filter 3, (f) indicates a second carrier signal outputted from the second bandpass filter 4, (g) indicates an inverted signal of the first carrier signal outputted from the first phase inverter 5, (h) indicates an inverted signal of the second carrier signal outputted from the second phase inverter 6, and (i) indicates an output FSK signal which is outputted from the lowpass filter 11 and supplied to the FSK signal output terminal 13 and the terminal 2₄ of the controller 2, respectively.

In this case, the first bandpass filter 3 has a pass band with the frequency 1200 Hz as the center. When the first bandpass filter 3 is driven by the second clock pulse of 600 pps outputted from the terminal 1₁ of the pulse generator 1, the first bandpass filter 3 outputs a first carrier signal corresponding to a cosine wave of 1200 Hz. The second bandpass filter 4 has a pass band with the frequency 1800 Hz as the center. When the second bandpass filter 4 is driven by the second clock pulse of 600 pps in like manner, the second bandpass filter 4 outputs a second carrier signal corresponding to a cosine wave of 1800 Hz. The first phase inverter 5 phase-inverts the first carrier signal to generate an inverted signal of the first carrier signal. The second phase inverter 6 phase-inverts the second carrier signal to generate an inverted signal of the second carrier signal. The first through fourth controllable switches 7 through 10 are respectively supplied with the first carrier signal, the inverted signal of the first carrier signal, the second carrier signal and the inverted signal of the second carrier signal and transmit and block those signals through their opening/closing operations. With the supply of select signals outputted from the four terminals 2₅, 2₆, 2₇ and 2₈ of the controller 2 to the control terminals of these controllable switches, only any one, e.g., the controllable switch 7 of the first through fourth controllable switches 7 through 10 is brought to the closing operation, so that the corresponding carrier signal is transmitted to the lowpass filter 11 through the closed controllable switch.

The operation of the FSK signal generator shown in FIG. 1 will now be explained with reference to FIG. 2.

In the first embodiment, the data signal is frequency-shifted between the first carrier signal of 1200 Hz and the second carrier signal of 1800 Hz to generate the FSK signal. There is a need to synchronize the phase of the first carrier signal and the phase of the second carrier signal with each other in order to generate the FSK signal continuous in phase state. However, the frequency 1200 Hz of the first carrier signal and the frequency 1800 Hz of the second carrier signal are placed in a relationship of 2:3 in this case. Therefore, if the first bandpass filter 3 whose passband frequency set as the center is 1200 Hz, and the second bandpass filter 4 whose passband frequency set as the center is 1800 Hz, are respectively driven by a second clock pulse having a sharp waveform, which is close to an impulse whose data clock rate is ½ and whose pulse rate is 600 pps, then a cosine wave signal (first carrier signal) of 1200 Hz and a cosine wave signal (second carrier signal) of 1800 Hz both set with the rising time of the input second clock pulse as a phase reference are respectively obtained at the outputs of the first and second bandpass filters 3 and 4.

Comparing the thus-obtained first carrier signal of 1200 Hz and second carrier signal of 1800 Hz with each other, an elapsed time of 2 cycles in the first carrier signal and an elapsed time of 3 cycles in the second carrier signal become exactly the same length in time. This means that when the first carrier signal has elapsed by one cycle (this corresponds exactly to an intermediate point of the second clock pulse of 600 pps), the first and second carrier signals are placed in a perfect antiphase state. Thus, the four carrier signals in total, which are made up of the first carrier signal, the phase-inverted first and second carrier signals, and the phase-inverted second carrier signal are formed, and the first through fourth controllable switches 7 through 10 are open/close-controlled when the binary data signal is expressed in codes 1 and 0. Consequentially, an FSK signal continuous in phase can be generated if any one of the four carrier signals is suitably selected and outputted.

The selection of the four carrier signals is performed in the following manner. That is, the first carrier signal of 1200 Hz is selected for each clock bit timing of the input data signal when its binary data is of a code 0, and the second carrier signal of 1800 Hz is selected when its binary data is of a code 1, respectively. And any one of the first through fourth controllable switches 7 through 10 is close-operated according to its corresponding select signal in such a manner that either the first carrier signal of 1200 Hz or the phase-inverted first carrier signal of 1200 Hz started from the same voltage as the voltage of a carrier signal waveform at the completion of the immediately preceding clock bit is selected when the first carrier signal of 1200 Hz is selected, and when the second carrier signal of 1800 Hz is selected, either the second carrier signal of 1800 Hz or the phase-inverted second carrier signal of 1800 Hz started from the same voltage as the voltage of the carrier signal waveform at the completion of the immediately preceding clock bit is selected.

FIG. 2(e) through 2(h) show signal selected states with respect to the first carrier signal, the second carrier signal, the phase-inverted first carrier signal and the phase-inverted second carrier signal. Heavy line portions of the respective carrier signal waveforms indicate portions of the signal waveforms cut and outputted by close-operating their corresponding first through fourth controllable switches 7 through 10. Assuming that when the binary data signal is of a code 0, the heavy line portion of the first carrier signal shown in FIG. 2(e) is selected, the second carrier signal shown in FIG. 2(f) or 2(h) is inevitably selected when the binary data signal reaches a code 1 at the following clock bit. Since, however, the voltage at the completion of the first carrier signal shown in FIG. 2(e) becomes equal to the voltage at the start of the phase-inverted second carrier signal shown in FIG. 2(h), the heavy line portion of the phase-inverted second carrier signal shown in FIG. 2(h) is selected at this clock bit. Likewise, the heavy line portions of the respective carrier signals are respectively selected as in the case where the heavy line portion of the phase-inverted first carrier signal shown in FIG. 2(g) is selected at the following clock bit, and the heavy line portion of the second carrier signal shown in FIG. 2(f) is selected at the following clock bit. When the heavy line portions of the respective carrier signals are sequentially selected and their cut-out waveform portions are combined together by the lowpass filter 11, such an FSK signal as shown in FIG. 2(i) is obtained.

The generation of the FSK signal having such contiguous phases is performed by supplying the select signals generated from the controller 2 to the first through fourth controllable switches 7 through 10. Upon generating such select signals, the controller 2 generates the select signals formed in accordance with the following input/output conditions. That is, respective numeric values 0 and 1 determined using such three types of input signal states that upon the completion of the immediately preceding clock bit, a) any of the input signal states is expressed in 1 when the voltage value of a cut waveform portion supplied to the terminal 2₄ is of a positive maximum value +1, and is expressed in 0 when the voltage value is of a negative maximum value −1, b) any of them is expressed in 1 when a square wave pulse supplied to the terminal 2₂ is of a polarity 1 and expressed in 0 when it is of a polarity 0, and c) any of them is expressed in 0 when an input data signal supplied to the terminal 2₁ is of a code 0, and expressed in 1 when it is of a code 1; and such two types of output signal states that d) any of them is expressed in 0 when the select signals outputted from the terminals 2₅ through 2₈ select the corresponding first carrier signal, and is expressed in 1 when they select the corresponding second carrier signal, and e) any of them is expressed in 0 when the selected carrier signal is of a non-phase inverted signal, and is expressed in 1 when the carrier signal is of a phase-inverted signal, are expressed in the following manner when they are shown in the representation of a)b)c)→d)e):

110→00 and 100→00

010→01 and 000→01

111→10 and 001→10

101→11 and 011→11

The controller 2 obtains the two outputs of d and e with respect to the three inputs of a, b and c. d and e are signals indicative of output signal states. If the output signal state is assumed to be 00 in this case, it means that the non-phase inverted first carrier signal of 1200 Hz is selected and outputted. At that time, only the select signal outputted from the terminal 2₈ is 1 and the select signals other than it result in 0. If the output signal state is assumed to be 01, it means that the phase-inverted first carrier signal of 1200 Hz is selected. At that time, only the select signal outputted from the terminal 27 results in 1 and the select signals other than it reach 0. Likewise, if the output signal state is assumed to be 10, it means that the non-phase inverted second carrier signal of 1800 Hz is selected and outputted. At that time, only the select signal outputted from the terminal 26 becomes 1 and the select signals other than it result in 0. If the output signal state is assumed to be 11, it means that the phase-inverted second carrier signal of 1800 Hz is selected and outputted. At that time, only the select signal outputted from the terminal 25 reaches 1 and the select signals other than it become 0.

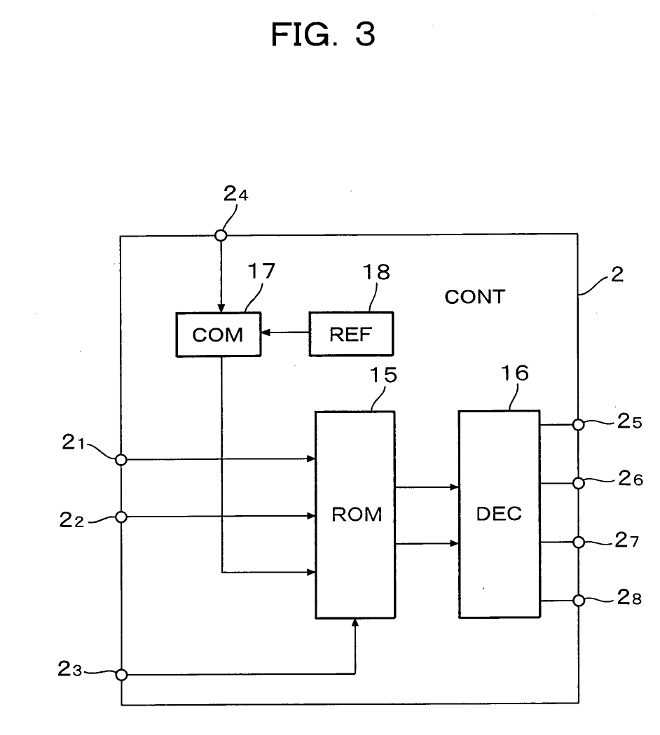

Now, FIG. 3 is a block diagram showing a first specific configuration example of the controller 2 shown in FIG. 1.

As shown in FIG. 3, the controller 2 is equipped with a read only memory (ROM) 15, a decoder (DEC) 16, a voltage comparator (COM) 17, and a reference voltage generator (REF) 18. Incidentally, the same components as those shown in FIG. 1 are given the same reference numerals in FIG. 3.

In the controller 2, the voltage comparator 17 has a first input terminal electrically connected to a terminal 2₄, a second input terminal electrically connected to an output terminal of the reference voltage generator 18, and an output terminal electrically connected to a third address input terminal of the ROM 15. The read only memory 15 has a first address input terminal electrically connected to a terminal 2₁, a second address input terminal electrically connected to a terminal 2₂, a fourth address input terminal electrically connected to a terminal 2₃, and two output terminals respectively electrically connected to two input terminals of the decoder 16. The decoder 16 has a first output terminal electrically connected to a terminal 2₅, a second output terminal electrically connected to a terminal 2₆, a third output terminal electrically connected to a terminal 2₇, and a fourth output terminal electrically connected to a terminal 2₈.

In this case, the read only memory 15 writes 00 into addresses 110 and 100 respectively, writes 01 into addresses 010 and 000 respectively, writes 10 into addresses 111 and 001 respectively, and writes 11 into addresses 101 and 011 respectively in advance so as to meet the above relationship between a, b and d, and d and e. When the code 00 is inputted, the decoder 16 outputs a select signal 1 to the terminal 2₈ alone and outputs 0 to the terminals 2₅ through 2₇ respectively. When the code 01 is inputted, the decoder 16 outputs the select signal 1 to the terminal 2₇ alone and outputs 0 to other terminals 2₅, 2₆ and 2₈ respectively. When the code 10 is inputted, the decoder 16 outputs the select signal 1 to the terminal 2₆ alone and outputs 0 to other terminals 2₅, 2₇ and 2₈ respectively. When the code 11 is inputted, the decoder 16 outputs the select signal 1 to the terminal 2₅ alone and outputs 0 to other terminals 2₆ through 2₈ respectively.

The controller 2 having the above configuration is operated as follows:

When such an output FSK signal as shown in FIG. 2(i) is applied to the input terminal 2₄, the voltage comparator 17 compares the FSK signal with a reference voltage (0 v in this case) supplied from the reference voltage generator 18. If the level of the FSK signal is higher than 0 v at this time, then the voltage comparator 17 outputs a code 1. If the level of the FSK signal is lower than 0 v, then the voltage comparator 17 outputs a code 0. They are supplied to the read only memory 15.

Since the read only memory 16 performs the writing into the addresses in accordance with such an input condition as to meet the above relationship in advance as mentioned above, the select signals placed under the input condition are supplied from the terminals 2₅ through 2₈ to the first through fourth controllable switches 7 through 10, so that the waveforms of the corresponding first carrier signal, phase-inverted first carrier signal, second carrier signal and phase-inverted second carrier signal are cut out at the first through fourth controllable switches 7 through 10. Their cut waveforms are combined together by the lowpass filter 11 to form an output FSK signal. This output FSK signal is always continuous in phase state.

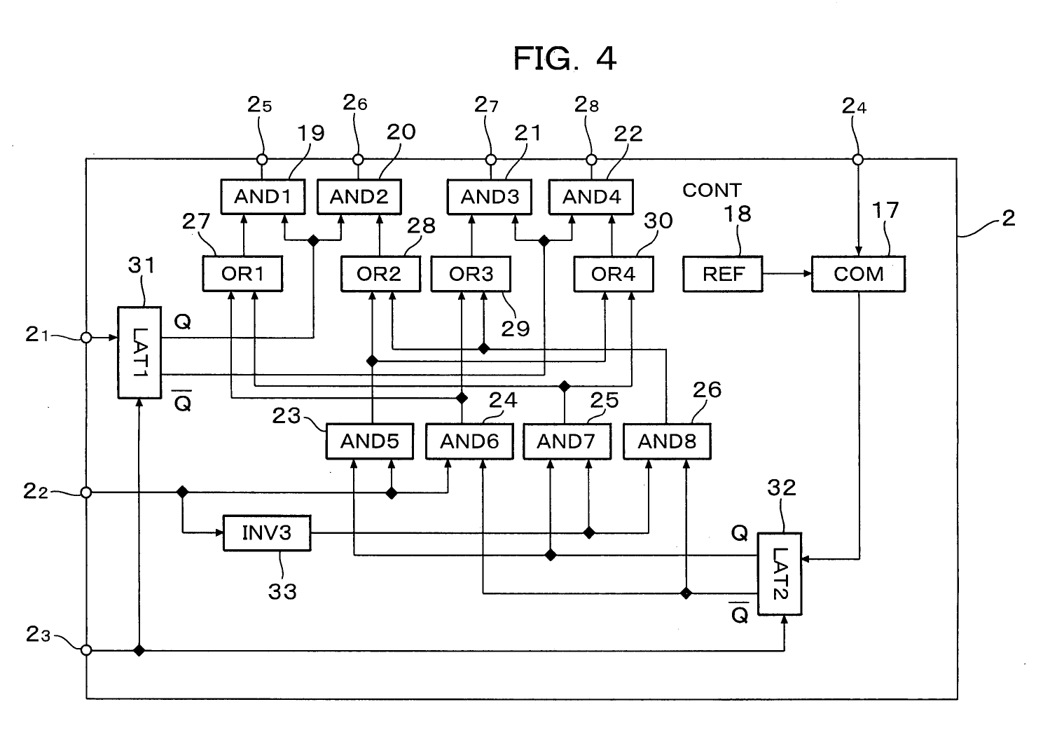

Next, FIG. 4 is a block diagram showing a second specific configuration example (hereinafter called “second configuration example”) of the controller 2 shown in FIG. 1.

As shown in FIG. 4, the controller 2 according to the second configuration example comprises first through fourth AND circuits (AND1 through AND4) 19 through 22, fifth through eighth AND circuits (AND5 through AND8) 23 through 26, first through fourth OR circuits (OR1 through OR4) 27 through 30, a first latch circuit (LAT1) 31, a second latch circuit (LAT2) 32, and a phase inverter IINV) 33. In terms of others, the same constituent elements or components as those shown in FIG. 3 are given the same reference numerals respectively. The controller 2 makes use of normally-used general-purpose logic circuits such as AND circuits, OR circuits, etc. and is set to an IC configuration in its entirety. Their components are interconnected with one another as shown in FIG. 4.

The controller 2 according to the second configuration example is achieved by utilizing the configurations of the read only memory 15 and decoder 16 shown in FIG. 3 and their functions in combination with the logic circuits. The operation of the controller 2 is basically identical to that of the controller 2 shown in FIG. 3. Therefore, the operation of the controller 2 according to the second configuration example will further not be described.

When the controller 2 is configured using a plurality of general-purpose logic circuits, other various configuration examples are considered as ones operated in the same manner as well as the above configuration examples. For example, the controller 2 may also be set to such a configuration example that it is configured by eight AND circuits mutually supplied with three inputs and four OR circuits that collect or fix up the outputs of these AND circuits two by two, so as to meet a relationship of the input/output of signals or pulses.

Meanwhile, when one of four types of carrier signals, i.e., the first carrier signal, second carrier signal, phase-inverted first carrier signal and phase-inverted second carrier signal is selected at any of the first through fourth controllable switches 7 through 10, the first carrier signal and the second carrier signal are frequency-shifted at the same phase points when the selected signal is frequency-shifted from the first carrier signal to the second carrier signal or from the second carrier signal to the first carrier signal as shown in FIG. 2(i). Therefore, while the frequency shifting is seemingly done smoothly, the angular rates of the first carrier signal and the second carrier signal change stepwise and hence discontinuous portions actually occur therein. If a slight gap or clearance occurs in time between the first carrier signal and the second carrier signal upon switching of the first through fourth controllable switches 7 through 10, then an FSK signal results in one having a slight discontinuous characteristic such as an instantaneous interruption at a portion of its occurrence. In order to eliminate such a discontinuous characteristic of FSK signal, the lowpass filter 11 is connected and disposed immediately before the FSK signal output terminal 13 to bring discontinuity between the first carrier signal and the second carrier signal to a smooth state, whereby the FSK signal is outputted in a state close to a more continuous characteristic.

The above description has been made of the example in which when the FSK signal is formed, the binary data signal of 1200 bps is frequency-shifted to the first carrier signal of 1200 Hz as the frequency and the second carrier signal of 1800 Hz as the frequency to form the corresponding FSK signal. According to the present example, when a data rate is set to 1, a shift frequency is selected as one having a simple numerical relationship that it is doubled with respect to the data rate and becomes 1.5 times the data rate. Even though the shift frequency is doubled with respect to a data rate 1 and becomes twice the data rate 1, for example even at other times, i.e., the first carrier signal of 1200 Hz and the second carrier signal of 2400 Hz (modulation index=1.0) are used, the present invention can be applied in like manner. Since the first carrier signal of 1200 Hz and the second carrier signal of 2400 Hz have a relationship of 1:2 in this case, the first bandpass filter and the second bandpass filter are respectively driven by a clock pulse of 1200 pps. Therefore, the cosine wave signals (first carrier signal and second carrier signal)

outputted from the first bandpass filter and the second bandpass filter always become inphase with respect to each bit clock. Therefore, since there is no need to use such phase-inverted carrier signals as mentioned above, only the first and second controllable switches are used, and the first carrier signal of 1200 Hz and the second carrier signal of 2400 Hz may simply be selected by the first and second controllable switches.

While the preferred forms of the present invention have been described, it is to be understood that modifications will be apparent to those skilled in the art without departing from the spirit of the invention. The scope of the invention is to be determined solely by the following claims.

What is claimed is:

1. An FSK signal generator that carries out FSK corresponding to codes of an input data signal to generate an FSK signal lying in a low frequency band, comprising:
a pulse generator that generates a first clock pulse of a frequency n equal to a baud rate of the data signal, a second clock pulse of a frequency n/2 equal to ½ of the frequency n, and a square wave pulse of a frequency n/2 respectively;
a first bandpass filter that has a pass band with the frequency n as the center and outputs a first carrier signal of a frequency n by driving of the second clock pulse;
a second bandpass filter that has a pass band with a frequency 1.5n as the center and outputs a second carrier signal of a frequency 1.5n by driving of the second clock pulse;
a carrier signal selection circuit comprising:
a first controllable switch supplied with the first carrier signal,
a second controllable switch supplied with a phase-inverted first carrier signal,
a third controllable switch supplied with the second carrier signal, and
a fourth controllable switch supplied with a phase-inverted second carrier signal; and
a controller that generates select signals selected and formed according to respective polarities of the data signal and output FSK signal and the square wave pulse upon the supply of the first clock pulse,
wherein the select signals are supplied to said first through fourth controllable switches respectively and any selected one of said first through fourth controllable switches is close-operated to thereby generate an output FSK signal having contiguous phases upon frequency shifting between the first carrier signal and the second carrier signal.

2. The FSK signal generator according to claim 1, wherein said controller includes a comparator that generates a compared output obtained by comparing the output FSK signal with a reference potential, a ROM in which the data signal, the square wave pulse, the second clock pulse and the compared output are respectively address-inputted, and a decoder that decodes the output of said ROM to form the corresponding select signal.

3. The FSK signal generator according to claim 1, wherein said controller includes a comparator that generates a compared output obtained by comparing an output FSK signal with a reference potential, a first latch circuit supplied with the data signal and the second clock pulse, a second latch circuit supplied with the compared output and the second clock pulse, and a logic circuit section including a plurality of logic gates that digitally process the outputs of said first and second latch circuits, and the select signals are outputted and formed from said logic circuit section.

4. The FSK signal generator according to any of claims 1 to 3, wherein the frequency n of the first carrier signal is 1200 Hz and the frequency 1.5n of the second carrier signal is 1800 Hz.

5. An FSK signal generator that performs FSK corresponding to codes of an input data signal to generate an FSK signal lying in a low frequency band, comprising:
a pulse generator that generates a clock pulse of a frequency n equal to a baud rate of the data signal and a square wave pulse of a frequency n/2 respectively;
a first bandpass filter that has a pass band with the frequency n as the center and outputs a first carrier signal of a frequency n by driving of the clock pulse;
a second bandpass filter that has a pass band with a frequency 2n as the center and outputs a second carrier signal of a frequency 2n by driving of the clock pulse;
a carrier signal selection circuit comprising a first controllable switch supplied with the first carrier signal and a second controllable switch supplied with the second carrier signal; and
a controller that generates select signals selected and formed according to respective polarities of the data signal and output FSK signal and the square wave pulse upon the supply of the clock pulse,
wherein the select signals are supplied to said first and second controllable switches respectively and either selected one of said first and second controllable switches is close-operated to thereby generate an output FSK signal having contiguous phases upon frequency shifting between the first carrier signal and the second carrier signal.

6. The FSK signal generator according to claim 5, wherein the frequency n of the first carrier signal is 1200 Hz and the frequency 2n of the second carrier signal is 2400 Hz.
